(19) United States
(12) Patent Application Publication
(10) Pub. No.: US 2013/0185177 A1
(43) Pub. Date: Jul. 18, 2013

(54) Method for Calculation of Construction Notice, Lien, and Bond Claim Deadlines Through Widget, Mobile Application and Web Application with Minimal Project Information

(71) Applicant: Scott Gerard Wolfe, New Orleans, LA (US)

(72) Inventor: Scott Gerard Wolfe, New Orleans, LA (US)

(21) Appl. No.: 13/490,645

(22) Filed: Jun. 7, 2012

Related U.S. Application Data
(60) Provisional application No. 61/499,609, filed on Jun. 21, 2011.

(51) Int. Cl. G06Q 40/00

(52) U.S. Cl. CPC G06Q 40/10
USPC 705/30

(57) ABSTRACT

This invention calculates construction notice, lien and bond claim deadlines specific to the user's project from inputting just 5 pieces of data: (1) the project's state; (2) the project's type; (3) the user's role in the project; (4) the role in the project of the party who hired the user; and (5) applicable “trigger dates” as follows: The State, User Role, Hired-by Role and Project type is selected by the user; the invention displays potentially applicable dates as pulled from database; the user inputs known dates; the invention retrieves deadline calculation/date counting logic and applies to information submitted; the deadline is displayed.

### CROSS-REFERENCE TO RELATED APPLICATIONS

This Nonprovisional Utility Patent Application claims the benefit of a previously filed provisional patent under 35 USC 199(e), the application number of which is 61499609.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### Mechanics Liens

Those furnishing labor, materials and/or services to private, state and federal construction projects around the United States have possible “mechanic's lien” claims in the event they are unpaid for their contribution. Popularly referred to as a “mechanic's lien,” the legal remedy is also called a “claim of lien,” “materialmen's lien,” “property lien,” “contractor lien,” “construction lien,” “statement of claim and privilege,” “notice of claim of lien,” and “stop work order.” When the labor, materials or services are furnished to a construction project owned privately (non-governmental ownership), the lien is placed against the property itself. When the labor, materials or services are furnished to a state or federal construction project, a lien against the government owned property is typically not available, but instead a “lien” is made against a bond under the federal Miller Act or each individual state's “Little Miller Act.” This lien remedy, which goes by many names and has different characteristics depending on the construction project's type, is referred to herein collectively as a “mechanic's lien.”

While the ability to file a mechanic's lien is uniformly available across the United States and its territories, the laws regulating its filing differs from state-to-state. In addition to each state having unique mechanic's lien laws, within these laws different treatment is afforded to construction participants depending on their role in the project (i.e. original contractor, subcontractor, architect, supplier, equipment lessor, etc), their tier in the project (i.e. their place in the contractual chain starting from the property owner or public entity commissioning work) and the type of construction project where services are furnished (i.e. commercial, residential, owner-occupied residential, industrial, oil & gas, state, federal, etc.).

To preserve one's right to file a mechanics lien, many states require project participants to meet pre-lien statutory notice requirements. In some states, notices are required before services are provided, and in others notices are required within a certain period before the lien is filed. In other states, notices are not required at all. These notices must meet statutory requirements, and must be sent according to the state's statutory service or delivery standards.

The act of filing a mechanics lien is also subject to varied legal requirements, with each state setting forth specific elements required within a mechanic's lien. After a lien is filed, many states require the mechanic's lien be served upon certain parties through pre-defined methods.

Finally, the mechanic's lien is a temporary encumbrance on private property or a surety bond. The encumbrance lasts for a specific period of time as provided by each jurisdiction's statute, and the encumbrance expires at the end of this time period unless action is taken by the lien claimant. In some jurisdictions, the mechanic's lien claim may be “extended” through a supplemental filing. When unable to extend or further extend a lien, the mechanic's lien claim must be “foreclosed upon” by filing an action seeking foreclosure in a designated court of law.

### Web Applications, Mobile Applications, and Widgets

The World Wide Web (WWW) is a well-known network of computers, whereby users around the world can access information displayed within a web browser. Typically the user accesses certain web pages which are displayed to the user through the HTML (Hyper-Text Markup Language) protocol. The user calls and retrieves specific HTML pages by requesting the page through a known URL (Uniform Resource Locator) using HTTP (HyperText Transfer Protocol).

Using certain computer languages such as PHP, Javascript, and HTML, listed here illustratively only and as examples, it has become common for companies and individuals to write applications that run and operate through web browsers on the world wide web. These web applications are similar to software applications that are written to operate on a user's desktop, except that they run through web browsers on the web.

Typically, a user will visit a certain website and be required to login to their account. Once logged in, the user will have access to the web application and its features. A web application can be designed to appear on a web browser access via a personal computer, or on a “mobile browser,” which is a web browser optimized for viewing on a mobile device.

Although web applications viewing on a standard web browser may be viewed on a mobile device through a mobile web browser, mobile devices also have the ability to run native mobile applications. These applications are optimized to operate on a mobile device (such as an iPhone or iPad, or an Android OS device) with or without the use of an internet connection. The user opens the application on his or her mobile device and is able to view, alter and interact with the application without the use of a browser.

Next, a Product Ordering Interface is an interface on the WWW that a user accesses through an HTTP request. Here, the user will find the ability to order certain products from the website, including, in the instance of this invention, mechanic's liens, bond claim forms, notices, lien cancellations, and similar products.

Finally, a “widget” is a term of art defined by Wikipedia as “a small application that can be installed and executed within a web page by an end user.” Or more further described therein as “a stand-alone application that can be embedded into third party sites by any user on a page where they have rights of authorship.” Other terms used to describe web widgets include: portlet, gadget, badge, module, webjit, capsule, snippet, mini and flake.

A widget may be installed on any web page, displaying content to the viewer, or offering a certain application or function to the viewer. When an application or function is offered, the widget runs a script stored on the originating server, such that the viewer is able to complete a function within the widget without the host-site storing the function's code and framework.

### Deadline Calculators and Lien Deadline Information Databases

For quite some time, individuals and companies have offered resources to help construction participants understand and calculate the timeframe available to them to file construction notices, liens and bond claims across the country.

Most of these resources have been in paper format, simply separating the lien laws and lien law charts by state, and providing readers with a table of contents to the data. Some paper resources are more sophisticated, allowing users to move cardboard forms within a cardboard capsule so that a particular state will display in a carved out window; when a state is selected, that state's lien laws (or a summary thereof) will be displayed. Still, however, the reader would have to decipher which laws apply to their particular station. Further, these lien law summaries are merely a compilation of the lien laws across the United States and its territories.

With the advent of computer software and the Internet, lien law resources have gotten a bit more usable.

Software users and web visitors have a few options where they can use computer databases to decode some of the lien law information. For instance, a user using one of these databases can select their state and be shown the general lien law in that state. In another instance, which is more specific, the user may use a software application to house detailed information about their construction project and the system will—after gathering all this project information—ask the user to provide generic work performance dates and/or answer pre-programmed questions about the project, and from all this information, display more specific database information about the construction project's applicable lien laws.

In addition to applications and database information systems that provide information about lien laws, there are a variety of generic date/deadline calculators in the marketplace. These calculators typically calculate a set number of days, months or years from a given date, and schedule notifications when the deadline approaches.

However, all of the generic deadline calculators and more specific database systems for construction liens are inefficient in that: (i) They do not offer deadline information completely customized to the user's specific project and services; (ii) They are inefficient in that they request a substantial amount of information to associate it with the applicable deadline; (iii) They are part of a more complex project management software; (iv) They fail to request the correct “trigger dates” that are tailored to the project and the user; (v) They lack a easy-to-use backend for administrators to create deadline types without the use of coding; and (vi) They are inefficient in that they give no guidance to the user to ensure they are properly calculating their deadline.

### BRIEF SUMMARY OF THE INVENTION

This invention takes specific, limited information, inputted by a user, and uses that information to calculate deadlines for various required and/or voluntary notices, liens, and bond claims in each of the 50 States and U.S. Territories. Each state has different deadlines for the various notices and liens. The invention uses dates inputted by the user (“trigger dates”) and applies a set logic to automatically determine the deadlines applicable to that user based on their role in a particular project, and the state in which the project is located. Further, the internal logic of the deadline calculator is able to determine specifically which days to count (i.e. weekends, starting or ending day, etc.) for each individual state based upon the law of that state.

### BRIEF DESCRIPTION OF THE SEVERAL VIEWS OF THE DRAWING

FIG. 1 shows the user interface view where the user inputs information used by the deadline calculator to determine the appropriate deadlines (101-109), and the user view of the calculated deadlines and options available to the user at this point to track and manage the calculated deadlines (110-113).

FIG. 2 outlines the structure of information stored in the database. Each individual State has project types and user roles associated with it. Once a State is selected, the invention calls up and displays the project types and instructional information associated with that state in order. This process is repeated for the user role types associated with the State and the project selected.

FIG. 3 shows a sample administration panel wherein an administrator is able to add new user roles and hired-by roles and associate this information with individual states.

FIG. 4 shows a sample administration panel wherein an administrator is able to add new deadline information. The administrator selects a state, names the deadline, chooses the appropriate role and project type, and selects the internal logic used to calculate the specific deadline.

FIG. 5 shows a sample administration panel wherein an administrator is able to add new dates from which the deadline calculator can apply the internal logic, and associate those new dates with a particular state and certain project types.

FIG. 6 shows a user interface view of the deadline calculator as a widget or mobile app. The information and structure is as described in FIG. 1.

FIG. 7 shows a product ordering interface as viewed on a website by the user. In this interface, the deadline calculator appears as a sidebar into which the user may enter the required information which will result in the display of deadlines, instructions, and options specifically related to the state and dates provided.

FIG. 8 shows a view of the deadline calculator as a web application.

FIG. 9 is a visual outline of the deadline calculation process, by step.

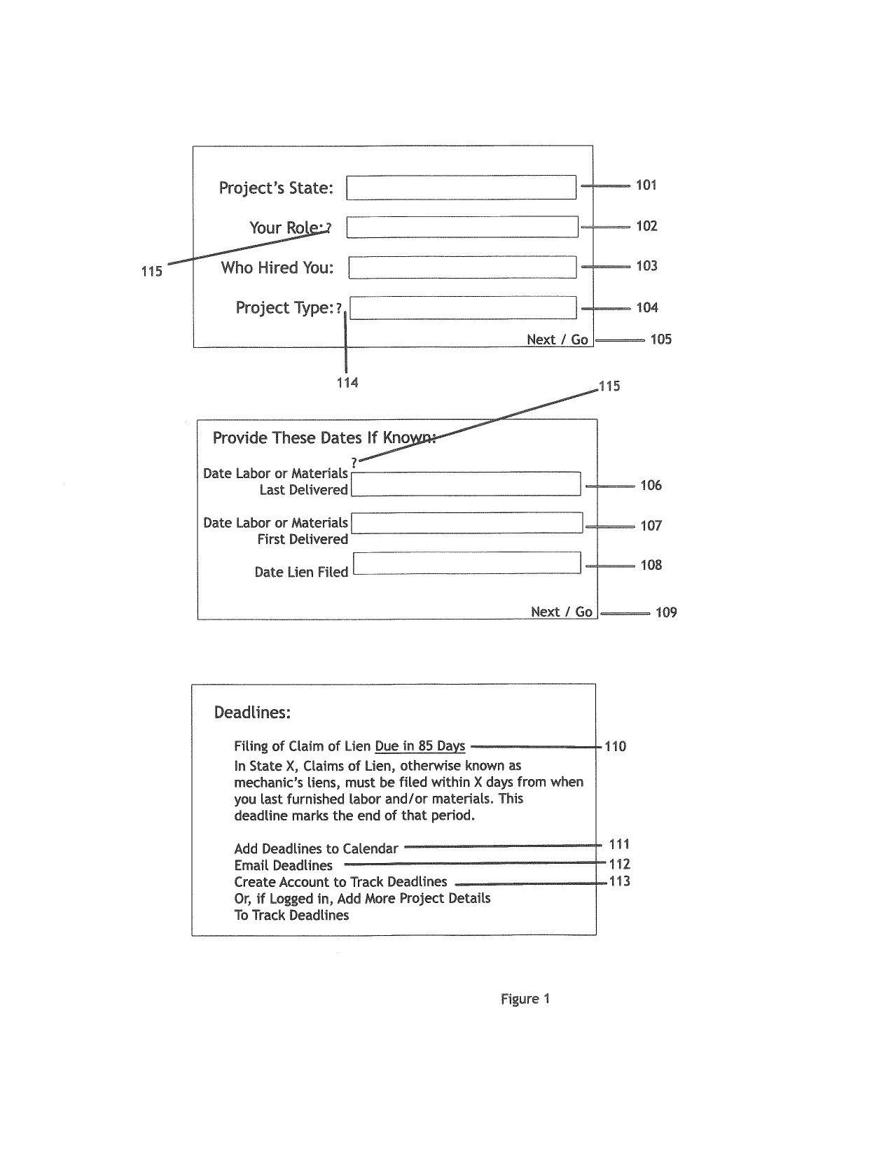

### DETAILED DESCRIPTION OF THE INVENTION

### A. Inputting Information and Generating Deadline From Minimal Project Information

This invention calculates construction notice, lien and bond claim deadlines specific to the user's project from inputting just 5 pieces of data: (1) the project's state, 101; (2) the project's type, 102; (3) the user's role in the project, 103; (4) the role in the project of the party who hired the user, 104; and (5) applicable “trigger dates,” 106-108.

The project's state is a static field (101), offering a choice of all 50 U.S. States and the U.S. Territories to the user for selection. The other fields are dynamic, using information and relationships stored in the MySQL database, together with the user's inputted data, to display only relevant choices for the following data requests.

From the chosen state, the system pulls related data to display: (i) the various project types in that state (104); and (ii) the various available project roles in that state (102).

Regarding (i), each state has different categories of projects that will affect what type of notices, liens and claims are due, and when. Information is stored in the database to associate project identification types with their associated states. Also stored in the database and displayed to the user through the applicable interface are associated “instructions,” such that a description is displayed to the user to explain the differences between each project type. Depending on the method the user accesses the invention, these instructions are displayed after request (through click on a ? or similar icon—see 114), or by displaying them next to the applicable field automatically.

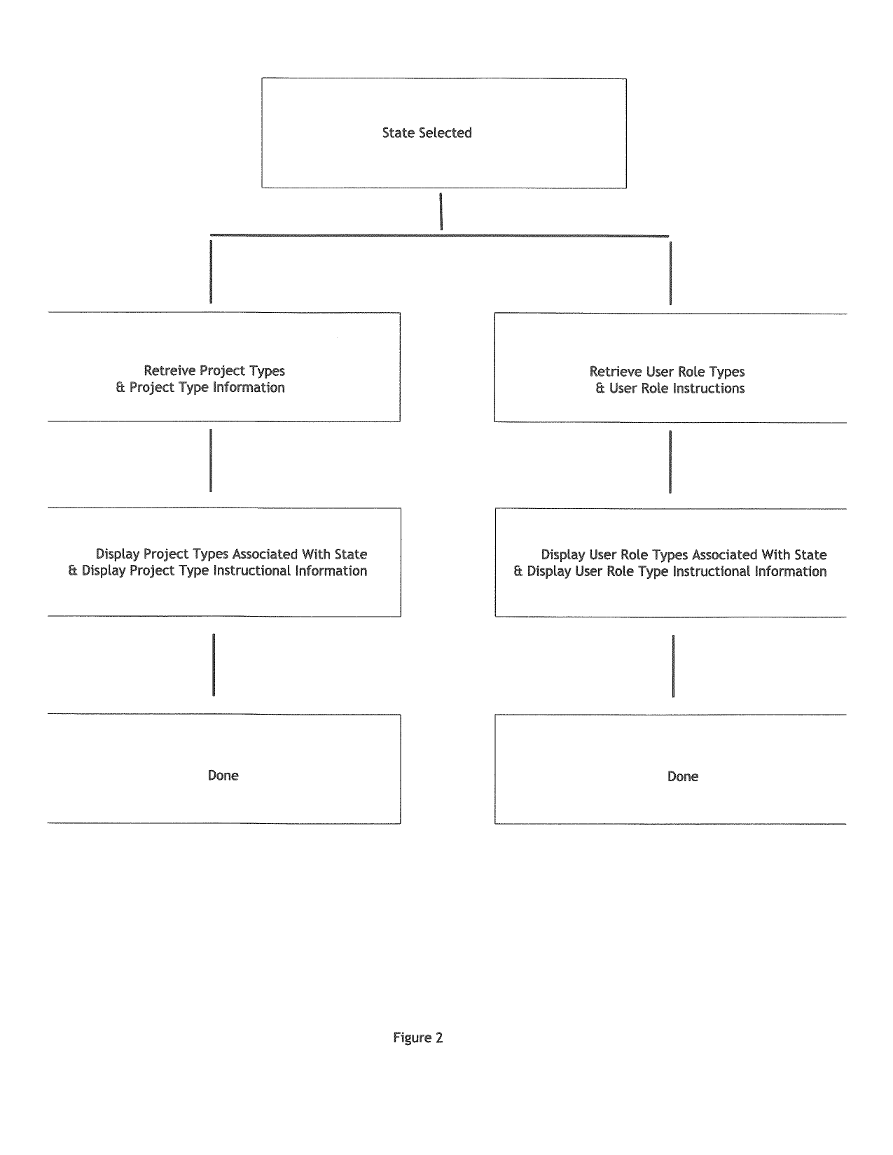

An administration panel is available to an administrator wherein s/he can add “Project Types” and “Instructions” to a database, and associate the Project Types and Instructions to a particular state. These are the project types that will display when the user selects the state. See FIG. 2.

Regarding (ii), each state has different categories of construction participants who are entitled to file mechanic liens or bond claims. The participant type who can file a lien depends on the state and the project type. Information is stored in the database to associate construction participant role identifiers with their associated states and project types. Also stored in the database and displayed to the user through the application interface are associated “instructions,”—accessible as described above, and shown in 115—such that a description is displayed to the user to explain the differences between each project type. See FIG. 2.

Based upon the project role selected, the user is asked to select the role of the party who hired it. Information is stored in the database creating rules as to which roles can be hired by whom, and only displays to the user roles of the “hiring party” that could apply to the data already selected. For example, an “original contractor” or “prime contractor” must be hired by the property owner, and accordingly, if the user selects that they are an “original” or “prime contractor,” they will only be allowed to select the “property owner” as the role of the party who hired them.

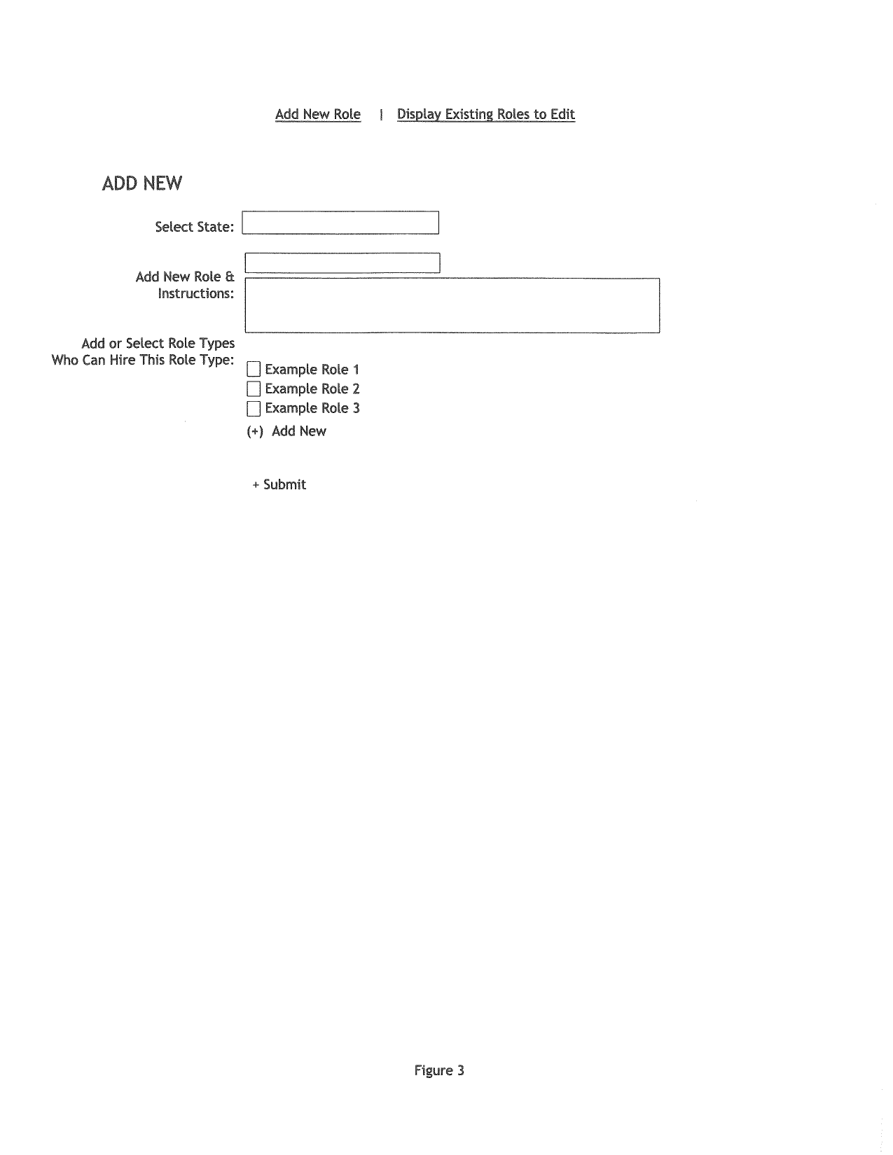

Sample Administration Panel where user roles and hired-by roles are created is shown in FIG. 3.

In addition to the database of information that is stored to ensure proper relationships between the project's state and type, and the user's role and hiring party's role, there is a database of “deadlines” and “dates” in the database.

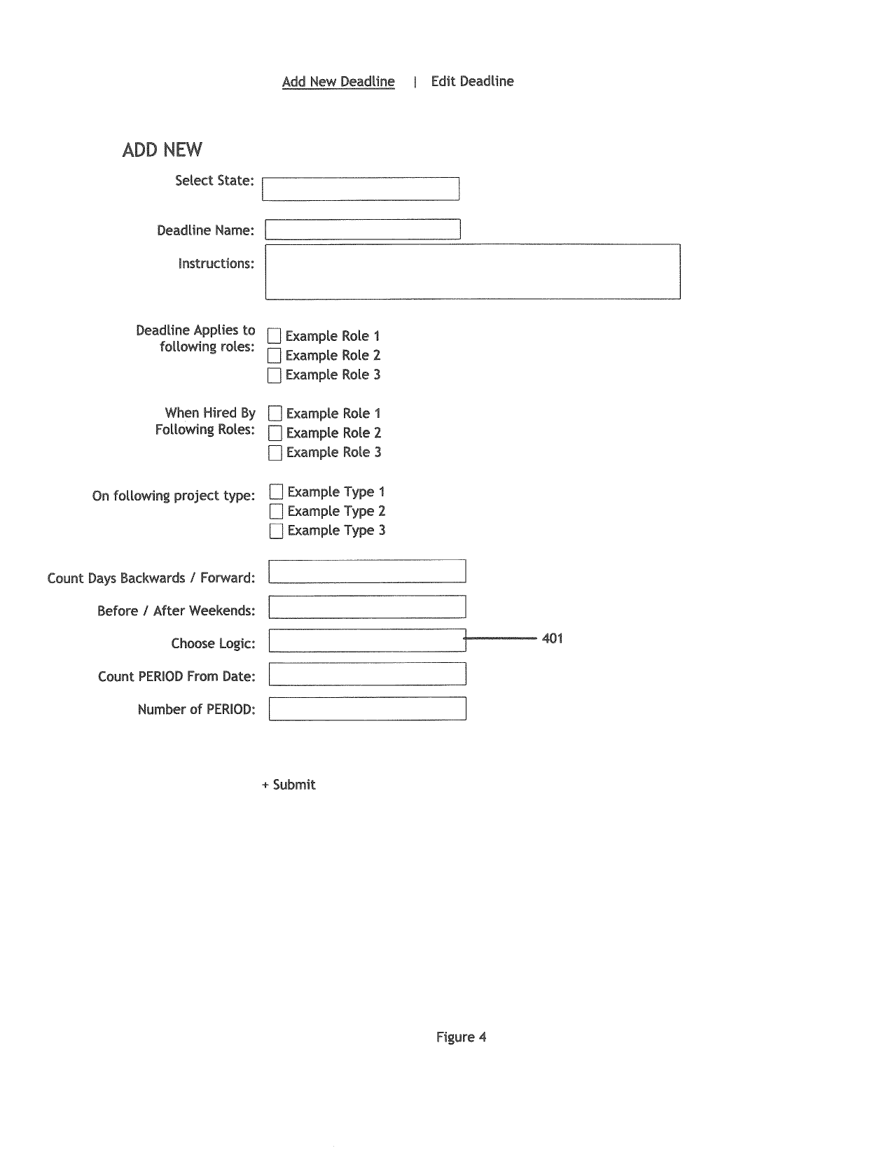

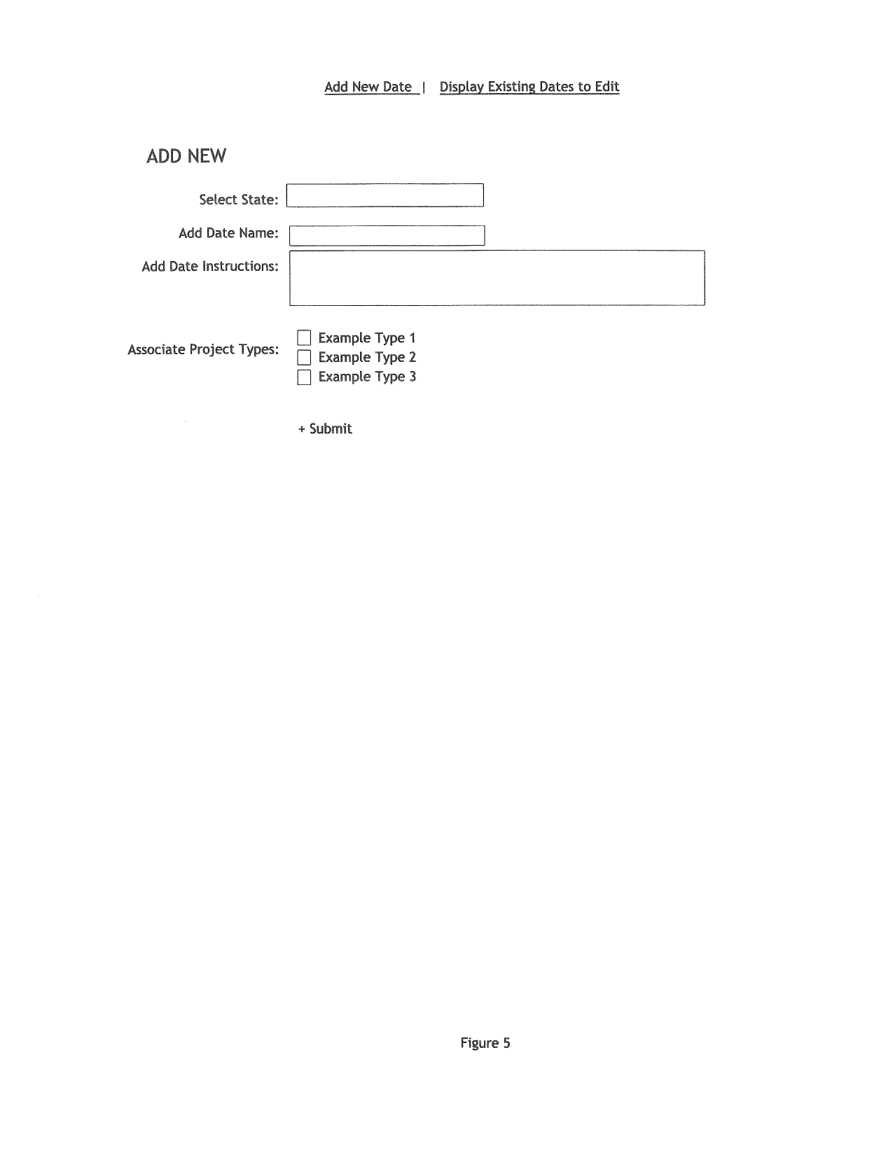

A backend Deadline Input System (FIG. 4) and Date Input System (FIG. 5) is built to allow administrators to create, modify and delete system deadlines, dates and products.

Dates are stored in the database with the following information: (1) Date Name (2) Associated States (3) Associated Project Types (4) Date Description/Instructions (Displayed through 115)

Deadlines are stored in the database with the following information: (1) Deadline Name (2) Associated State (3) Associated Project Type (4) Associated User Roles (5) Associated Hiring Party Roles (6) Deadline Description/Instructions (7) Deadline Due Before/After Holidays or Weekends Option* (8) Deadline Calculation Logic Option: (a) Calculating a certain number of days forward or backward from a specific date type; (b) Calculating a certain number of months forward or backward from a specific date type; (c) Calculating a certain number of years forward or backward from a specific date type; (d) Calculating a certain number of days from the beginning of a month from a specific date type; (e) Calculating a certain number of days from the beginning of a month, a certain number of months after a specific date type; (f) Calculating a certain number of days, months or years from two certain date types, rendering the deadline the earlier or later of the produced due date; (g) Making any of the foregoing deadline logic due dates repeat (401). When the applicable logic is chosen, the administrator gives a certain period after a certain trigger date when the deadline will accrue.
A separate database table captures holidays when recorders are closed by jurisdiction.

On the user-side of the system, the user provides the project state and type, as well as its role and the role of the party who hires it (hereinafter the 4-piece dataset). The system compares this entry with the back-end databased information determining all the Deadlines that could possibly apply to the chosen 4-piece dataset. These possibly applicable deadlines will accrue only after a certain time period counting from a specific date, and the system treats this date as a “trigger date,” in that inputting one of these “trigger dates” will trigger the related deadline. After receipt of the user's 4-piece dataset, the system displays the applicable trigger dates, requesting the user input the date data (105, 106-109)

Upon inputting the date data, the system then applies the databased and chosen deadline calculation logic to the inputted date, counting the required time period from the date provided. In counting the days, months or years from the trigger date, the system contemplates whether the deadline should end before or after weekends and holidays, and contemplates which days are holidays for that project's jurisdiction.

The calculated Deadline is then displayed to the user, with textual instructions specific to that user's project and services provided. The user can view how many days until the deadline expires, or can—by clicking on the countdown or calendar date (110)—=choose to see the exact calendar day when the deadline expires. 110-113.

### B. Post-Deadline Calculation Options From Device, Widget, Web Application

After the deadline is calculated from the Minimal Project Information, the options available to the user are as follows:

(1) If the deadlines are calculated through the Widget, or through a mobile application without logging into an account from the providing company, the user will have the option of (i) Downloading an .ics file to add the deadline to their desktop, online or mobile calendar application; 111 (ii) Entering (on Widget and Mobile Device) or associating (on Mobile device) email addresses to the deadline and having the deadline information sent to those addresses; 112 or (iii) Creating an account with the providing company's lien management service, and creating a record for the project to manage the project and the project's deadline therein, which includes providing the project's address and other identifying information to track and manage the deadline within a lien management system. The generic function of the lien management system itself is not part of this provisional patent application. 113.

(2) If on a Mobile Device logged into an account with the providing company, or if within the providing company's lien management system's web application, after calculating a deadline from the Minimal Project Information, the user can create a new project record to track and manage the project more permanently through the management system.

The Deadline Calculator is shown in the following figures being used in various settings:

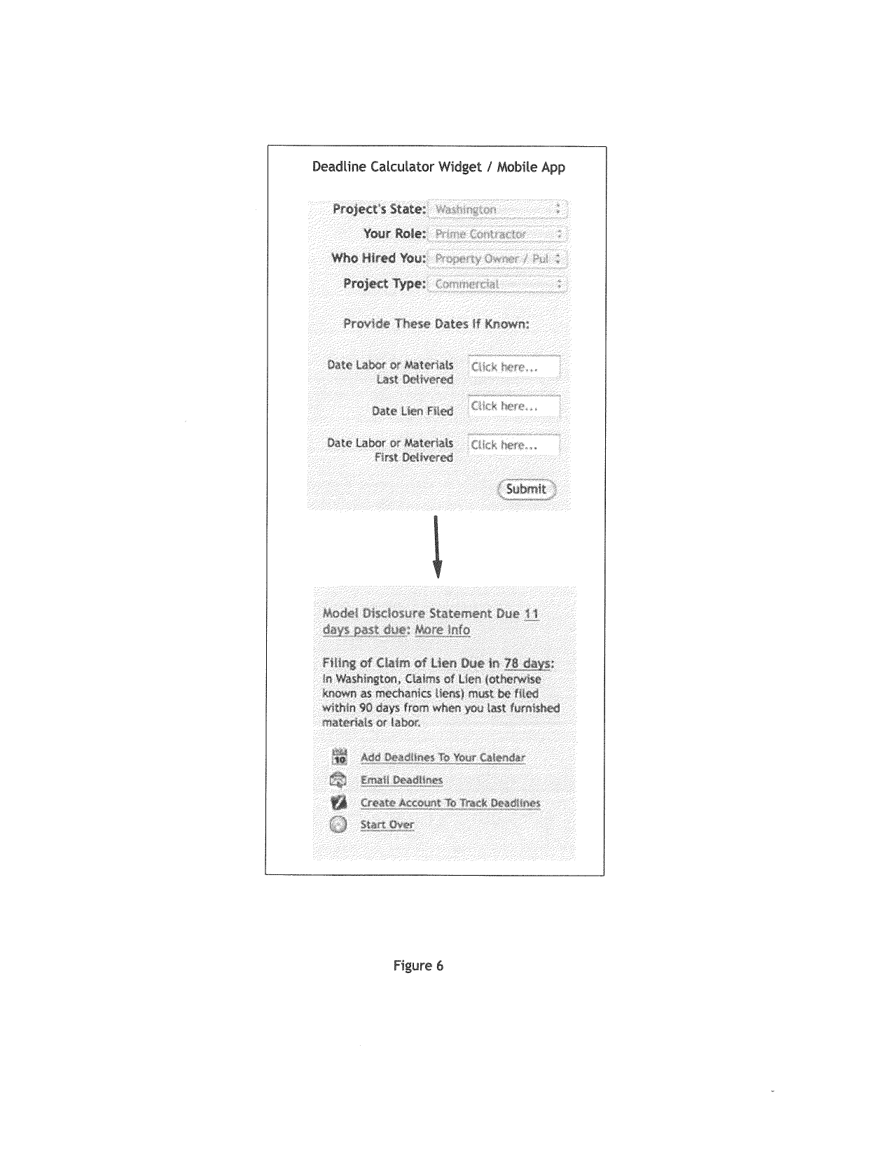

### FIG. 6: Mobile Application/Widget

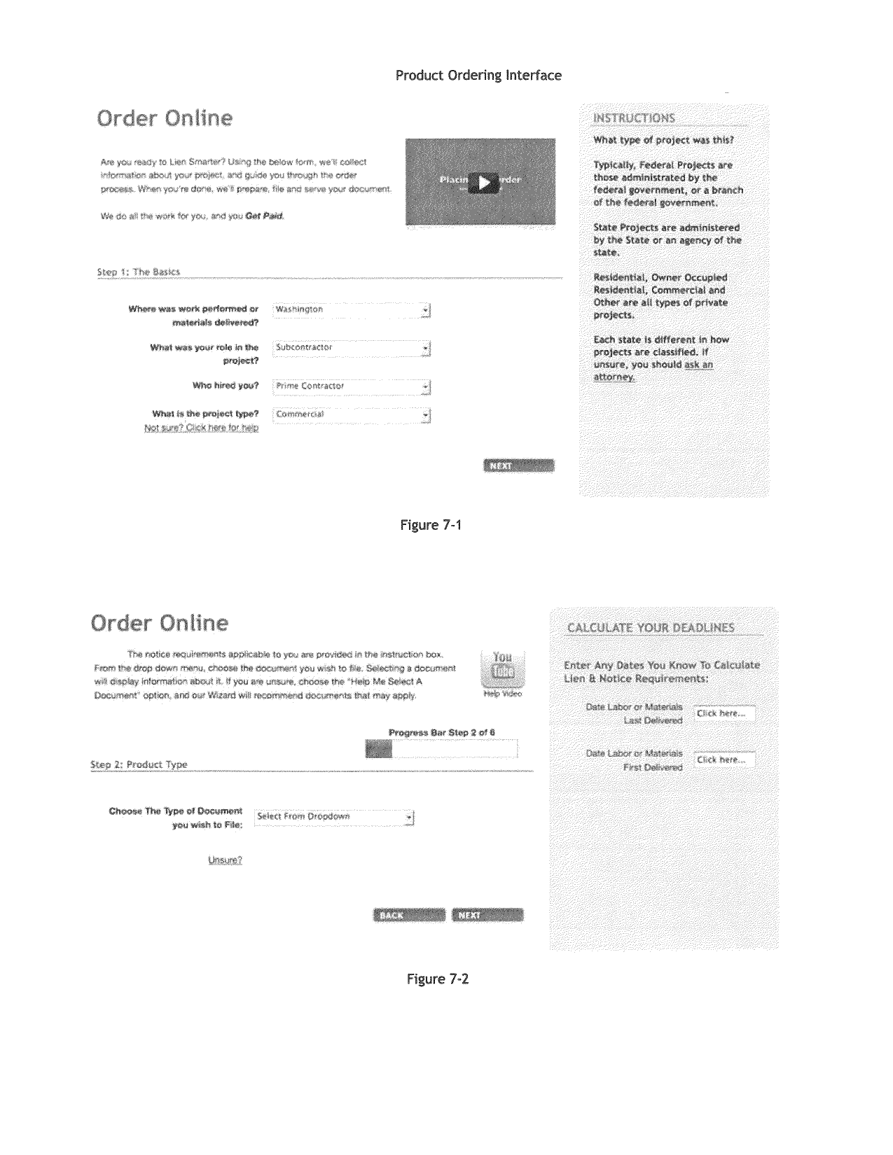

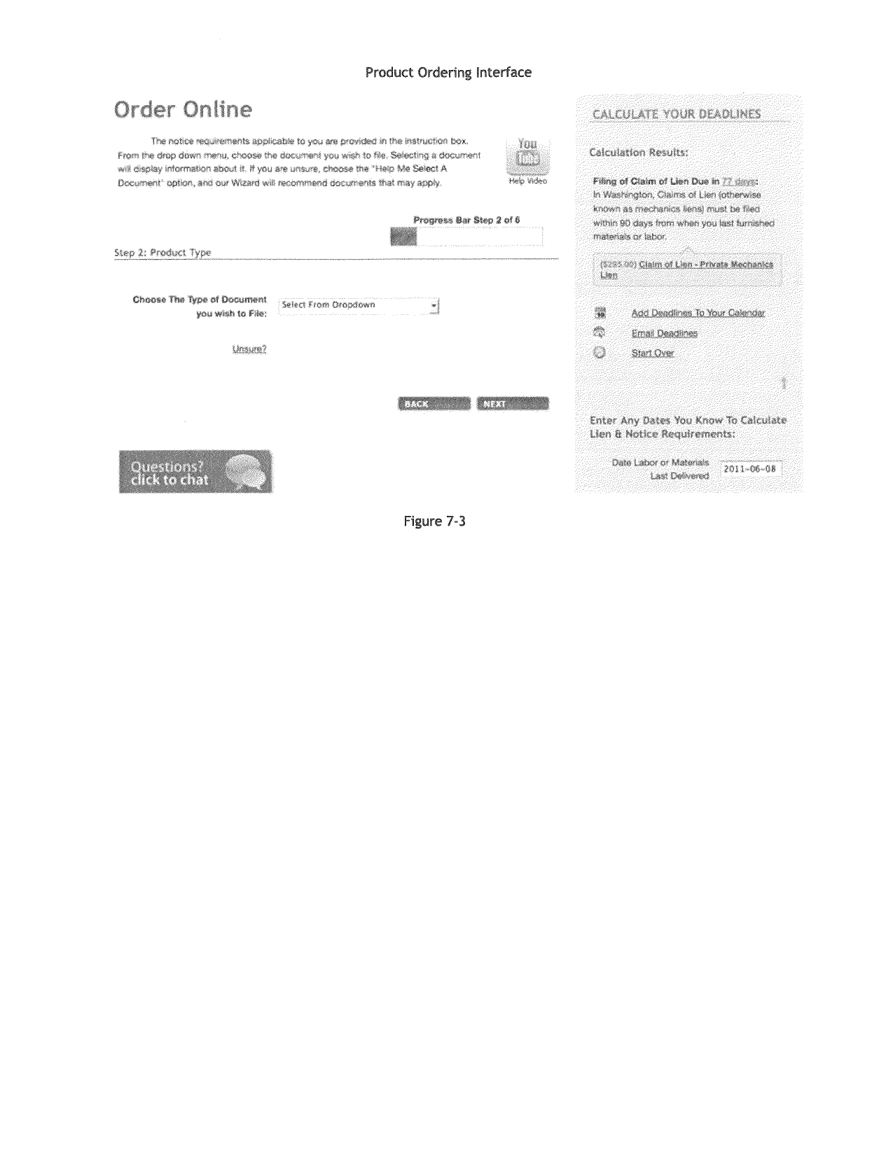

### FIG. 7: Product Ordering Interface

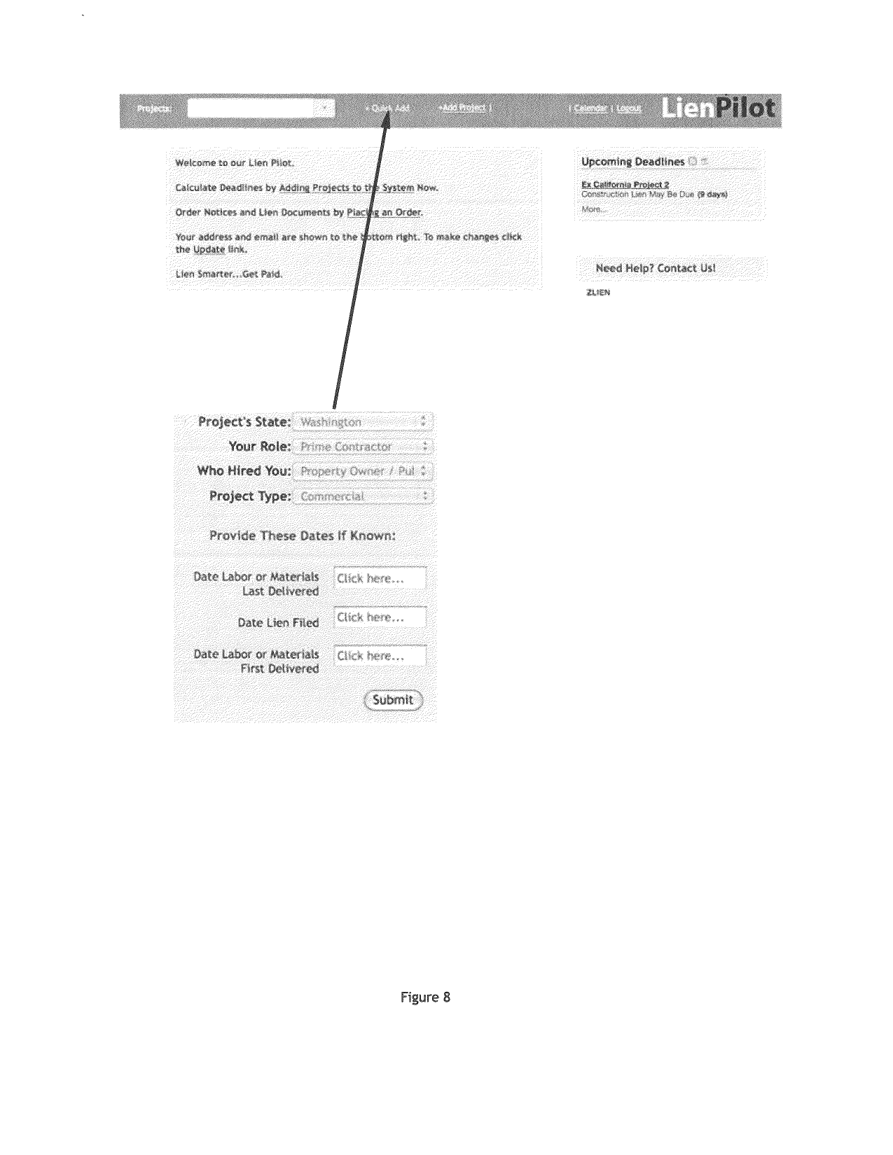

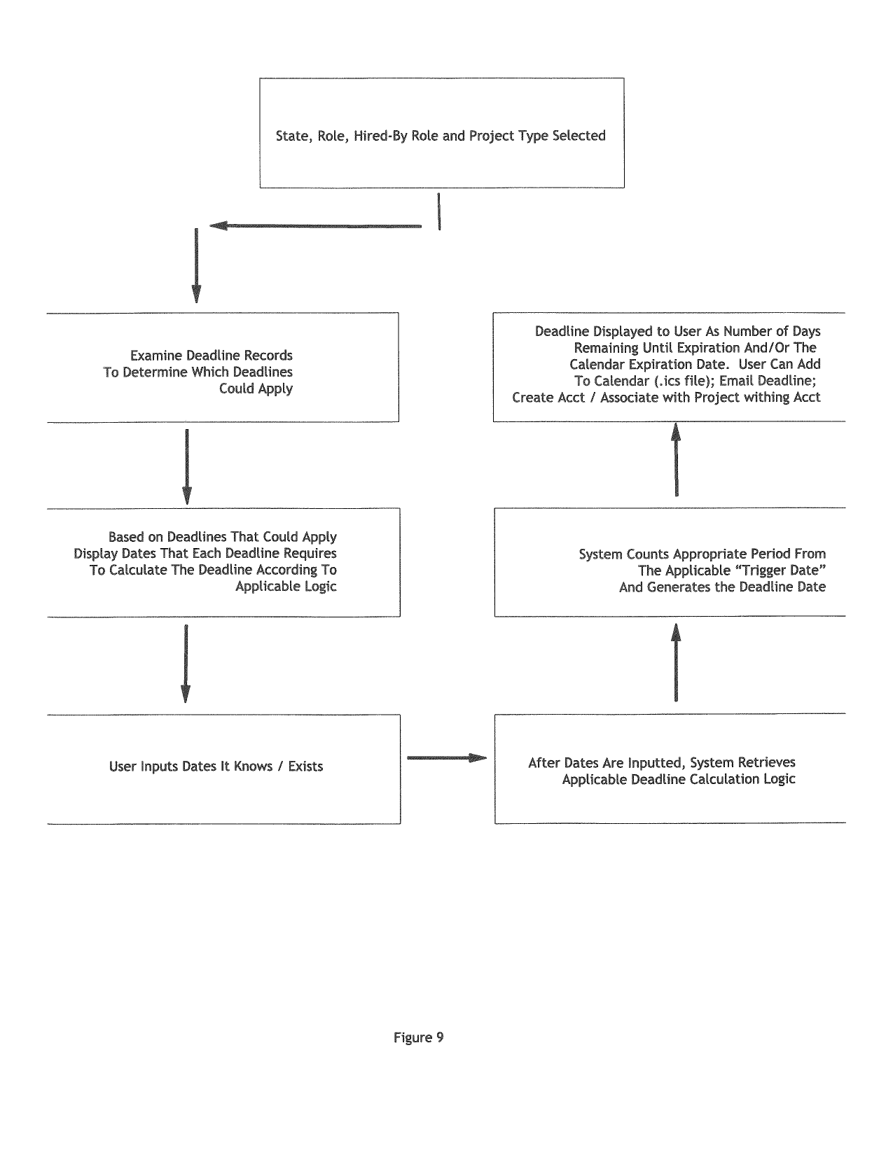

FIG. 8: Web Application

1) A method of calculating or managing mechanics lien, bond claim, miller act claim, lien claim, preliminary notice, notice to owner, construction notice, notice of intent to lien, pre-lien notice and related items (all hereinafter collectively referred to as “Mechanics Lien”) deadlines, or for displaying laws or regulations related to a party's particular Mechanics Lien rights on a particular job, based on the acquisition from the user of minimal data about the user's subject project which includes:
(i) the subject project's location within the United States or its territories;
(ii) the subject project's “type;”
(iii) The role of the user in the subject project;
(iv) The role of the party who hired the user in the subject project; and
(v) applicable “trigger dates;” all of which data is dependent upon the user's specific project information, as contemplated by the other claims of this invention.

2) A method of offering users a selection of available “Project Types” that can be selected within an intelligent form for the purposes of acquiring information about a subject project to perform the function within claim 1 that is dependent on the subject project's state, such that each state may have its own unique available “types” of projects.

3) A method of offering users a selection of available Project Roles that can be selected within an intelligent form for the purposes of acquiring information about a subject project to perform the function within claim 1 that is dependent on the subject project's state and the subject project's type, such that each state has its own unique available types of projects, and for each type of project, there may be separate and distinct “roles” that a user could have acted in a project.

4) A method of creating “trigger dates” for the purpose of displaying said dates to the user so the user can input the requested dates and calculate Mechanics Lien deadlines;
(i) said trigger dates being created by associating individual date records with states and project types, such that these certain date records will be available for inputting into the described system only when matched with the states and project types;
(ii) thereafter certain deadline records are created, associating these date records with deadline periods, the logic of counting days, months or years for the purposes of calculating the deadline, and the logic of which deadlines are applicable to which states, roles, project types, and hired by roles;
(iii) Thereafter, the triggered date created is only displayed to the user for the calculation and management of Mechanics Lien deadlines as described in claim 1 when applicable to the specific project information inputted by the user.

5) The method of claim 1 wherein a user of the system will receive Mechanics Lien deadline, law, regulation or similar information based on the subject data mentioned in claim 1 as (i), (ii), (iii) and (iv), but without the providing of either (v) data, (iv) data and/or (iv) and (v), by having the system make presumptions about the missing data, that in the case of:
(a) the (iv) data the missing data is equal to a selection of all the options available for the (iv) data;
(b) the missing (v) data, that the resulting Mechanics Lien law or deadline information will not be customized to the user's timing on the project, but instead be the display of generic information about the law as it relates to the project as a whole irrespective of individualized deadlines.
